(19) United States
(12) Patent Application Publication
(10) Pub. No.: US 2010/0177528 A1
(43) Pub. Date: Jul. 15, 2010

(54) LED Vehicle Eyelid Apparatus

(76) Inventors: Calvin Chuen Kam Law, Chino, CA (US); Georage Chien Feng Lee, Chino, CA (US)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/552,293

(22) Filed: Sep. 2, 2009

Related U.S. Application Data
(60) Provisional application No. 61/144,166, filed on Jan. 13, 2009.

(51) Int. Cl. B60Q 1/26; F21S 8/10

(52) U.S. Cl. 362/541; 362/545; 362/540

(57) ABSTRACT

A vehicular LED headlamp eyelid apparatus is disclosed. The vehicular headlamp eyelid apparatus is attached to a vehicle's headlamp and comprises a plurality of LED lights capable of illuminating in patterns signaled by the vehicle. The occlusion resulting from one or more segments of the LED eyelids modifies the overall appearance of the headlamp. The vehicular LED headlamp eyelid is made at least in part of lightweight material such that there results in little impact upon the drag profile of the vehicle.

### CROSS REFERENCE TO RELATED APPLICATION

This application claims the benefit of priority under 35 U.S.C. 119(e) to the filing date of U.S. provisional patent application No. 61/144,166 entitled “LED Vehicle Eyelid Apparatus” which was filed on Jan. 13, 2009 and is incorporated herein by reference.

### FIELD OF THE INVENTION

The present invention relates generally to a vehicular lighting device accessory. Specifically, the present invention is related to a vehicular lighting device accessory which modifies the light beam of the vehicle's headlamp and provides additional illumination by way of light emitting diodes.

### BACKGROUND OF THE INVENTION

Over the last few years, vehicular headlight modifications have become increasingly popular across a wide range of automobile enthusiasts. These aftermarket add-on components are primarily sought after for the aesthetic benefit provided to the vehicle. One type of vehicular headlight modification consists of partially covering portions of headlamps of a vehicle to create a streamlined, aggressive look. By altering the shape of the headlamps, the appearance of the front of the vehicle has been likened to the squinting eyes of a feline predator upon spotting its prey.

These modifications were initially done by using masking tape or similar device to mask off certain areas of the headlamp. This mask was then painted in the appropriate color to match the vehicle thereby creating the intended look with a rudimentary construction. Subsequent iterations of creating such an intended look evolved into the use of stickers, where one side of the sticker consists of the matching color of the vehicle while the other side is coated with an adhesive. Recently, after market manufacturers capitalized upon the difficult nature of achieving the above described effect through the introduction of readymade, solid plastic tailored to the design of headlamps of specific models of popular vehicles. As a result, the popularity of vehicular eyelids has increased substantially due to its associated ease of installation.

Vehicular headlamp eyelids are sought after by performance seeking enthusiasts as the. eyelids provide aerodynamic improvement. On some automobiles, manufacturers have chosen to focus on designing headlamps that are either aesthetically pleasing or congruent in design with relation to the rest of their vehicle lineup. Performance enthusiasts can gain the aerodynamic improvements and reduce their vehicle's drag profile by utilizing vehicular headlamp eyelids. When correctly installed, the eyelids smooth out the surface and minimize the gap between vehicle's body and headlamp, creating a flush plane which changes the appearance of the headlight and streamlines airflow across the face of the lamp.

The arrival of improved and efficient vehicular headlights, such as xenon headlamps (H.I.D. lights), has resulted in an increased demand for aftermarket conversions kits from the normal tungsten-halogen headlamps to xenon headlamps. However, such conversion kits often do not take into account that xenon headlamps have a tendency to generate significantly more glare for other drivers. Without projector housings, HID light scatters in every which direction producing a pronounced blinding effect for oncoming cars. Standard tungsten-halogen headlamps produce scattered light as well but their light is not nearly as bright as HID light. Scientific studies have shown that for any given intensity level, the light from xenon headlamps are 40% more glaring than the light emitted from the older tungsten-halogen headlamps. Therefore, even if the intensity is turned down, the scattering HID light will still exist and be bright enough to be hazardous to other drivers.

By utilizing vehicular headlamp eyelids, scattering can be reduced to relatively safe levels by eliminating light from being projected in unwanted directions, typically in the upward direction towards the eyelevel of drivers in oncoming vehicles. However, different safety concerns arise from such a reduction in scope and size of the headlight. The present invention provides all the benefits of a mundane vehicular headlamp eyelid of aesthetics improvements, aerodynamic improvements, and reduction of glare. However, the present invention also reduces the safety concerns of reduced headlight output and headlight signature through the use of LED lights embedded within the eyelid.

LED lights offer considerable advantages, such as lower system power consumption, more adaptable design configurations and longer lifespan, not available to other lighting systems. The LED lights attached to the eyelids provide added safety by functioning as auxiliary lights, capable of working in conjunction with the vehicle's exterior lighting system. In addition to the safety and economical benefits, LED lights are another means of enhancing the aesthetic appearance of the vehicle.

Rudimentary eyelids existing in the current marketplace are made of ABS plastic. ABS plastic is formed via a three dimensional mold which lack the precision of eyelids produced in alternative methods. ABS plastic is often bulky, rigid, non uniform, and does not lay flush against the body of the headlamp and vehicle, thereby resulting in an increased drag profile. In addition, ABS plastic is susceptible of cracking during hot summer days and cold winters. Long exposure to the sun can result in the formation of bubbles which lead towards deformity of shape. The present invention utilizes an improved manufacturing process that results in a more efficient, robust, and aesthetically appealing product. The present invention is cut by a laser machine with specific molds designed by CNC specifically for every car model.

### OBJECT OF THE INVENTION

It is an object of this invention to create an apparatus suitable for altering the aesthetics of a vehicle's headlamp, reducing the vehicle's drag profile, and increasing safety by focusing the projected beam of light thereby reducing scattered light and by utilizing LED lights as an auxiliary lighting system.

It is also an object of this invention to create an eyelid apparatus in a more efficient manner utilizing superior lightweight, flexible materials comprising vinyl, polyurethane, and carbon fiber.

### SUMMARY OF THE INVENTION

The present invention comprises an apparatus suitable for use as a vehicle headlamp eyelid that is capable of functioning as an auxiliary lighting system.

In one embodiment, the vehicle headlamp eyelid apparatus comprises of a plurality of segments, which can be arranged to produce the desired level of occlusion of the headlight.

In one embodiment, the vehicle headlamp eyelid is constructed at least in part of lightweight, flexible material. In one embodiment, said material comprises of vinyl. In another embodiment, said material comprises of acrylic. In another embodiment, said material comprises of carbon fiber. In another embodiment, said material comprises of polyurethane.

In one embodiment, the vehicle headlamp eyelid apparatus comprises of a plurality of LED lights whereby said LED lights are capable of lighting up at specific rates and in specific patterns with respect to whether the vehicle is turned on, is in motion, engaging its brakes, or indicating an imminent turn to the left or right.

In one embodiment, the LED lights in the vehicle headlamp eyelid are supplied electricity power by solar power with a battery reserve. In another embodiment, the LED lights are provided electricity power from the vehicle via an adapter.

### BRIEF DESCRIPTION OF THE DRAWINGS

FIG. 1 is a drawing of an embodiment of a single LED eyelid installed on top of a single vehicle headlamp in accordance with the present invention;

FIG. 2 is a drawing from a frontal view of an embodiment of the LED eyelids from FIG. 1 on installed on both of the vehicle's headlamps.

FIG. 3 is a drawing of a LED lighting component of an embodiment of an LED eyelid.

FIG. 4 is a drawing of an adapter of an embodiment of an LED eyelid to be attached to the vehicle.

### DETAILED DESCRIPTION OF THE EMBODIMENTS

The present invention is an LED eyelid. In the following description, specific details are set forth in order to provide a more thorough description of the present invention. It will be apparent, to one skilled in the art, that the present invention may be practiced without specific details. In other instances, well-known features have not been described in detail so as not to obscure the invention.

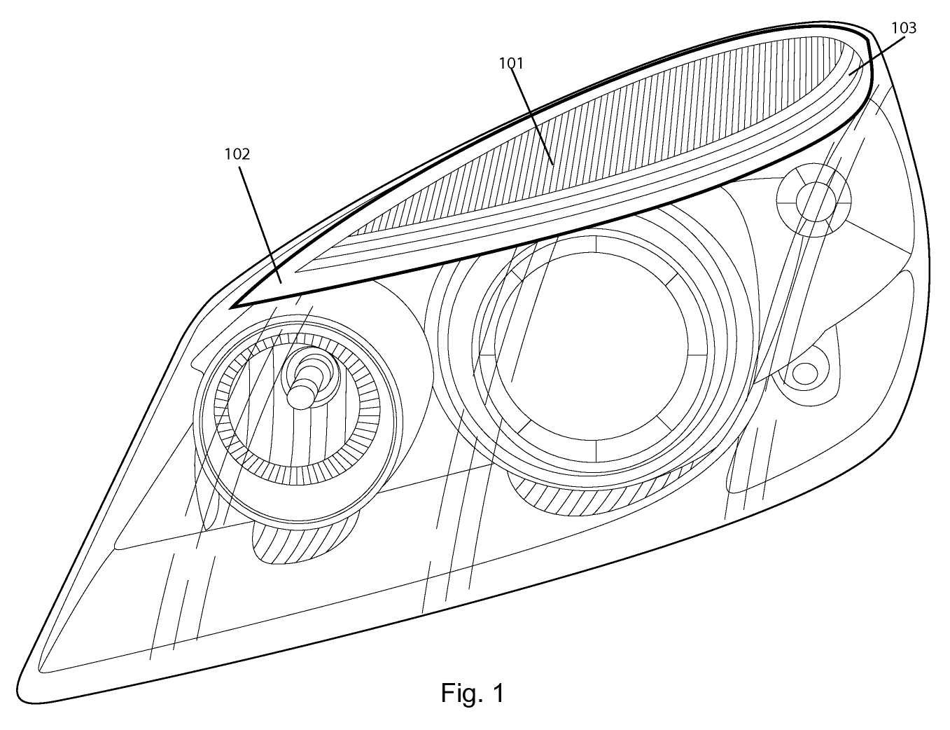

The present invention comprises a shell suitable for placement on the exterior of vehicular headlamps where at least one or more LED lights are attached to said shell. One embodiment of an LED eyelid in accordance with the present invention will be described with reference to FIGS. 1, 2, 3, and 4. Specifically, LED eyelids are of the type that is affixed onto the exterior surface of the vehicle's headlamps and includes LED lights embedded along the shell's edge.

In one embodiment, the present invention comprises of one or more LED eyelid segments. Each segment comprises a flexible, lightweight shell 101 and one or more LED light strips 105 attached to the underside 103 of the shell 101. The flexible, lightweight shell 101 has a front 102, generally with a convex surface facing outward, and a back 103, generally with a concave surface, that when installed, is attached to the exterior surface of the headlamp. LED's 104 are embedded along the outer edge of the back 103 of the shell 101 by way of a flexible LED light strip 105. Installation of one or more LED eyelid segments 101 occludes the beam of the light emanating from the headlamp thereby modifying the shape, focus, and intensity of the projected light beam.

In one embodiment, the shell 101 is constructed of lightweight, flexible materials suitable for placement on the exterior of a vehicle. Such materials include vinyl, polyurethane, carbon fiber, acrylic, and any other material exhibiting similar properties. The shell 101 is cut by a laser machine with specific molds designed by CNC specifically for every car model. Vinyl, polyurethane, acrylic, and carbon fiber are easier to cut than materials used in prior art, such as ABS plastic, allowing for the fabrication of a sleeker eyelid profile without sacrificing structural integrity or flexibility.

In one embodiment, the LED eyelid comprises multiple segments covering different portions of the headlamp. A common configuration consists of two segments with one segment installed along the top edge on the exterior of the headlamp and the other segment installed along the exterior of the bottom edge of the headlamp. In addition to modifying the headlight, eyelids reduce the vehicle's drag profile by improving upon the aerodynamics of the vehicle. Upon correct installation, the shell 101 of the eyelid smoothes out the surface plane and minimizes the gap between the vehicle's body and headlamp, creating a flush plane. The aerodynamic profile of the vehicle is improved due to streamlining of airflow across the vehicle's body onto the headlamps.

In one embodiment, one or more LED lights 104 are embedded within a flexible light strip 105. The flexible light strip 105 has a front side 106, which contains the LED lights 104, and a back side 107, which is attached or built into the underside or back 103 of the eyelid's shell 101. Safety concerns regarding the lowered intensity of headlight output and reduced headlight signature as a result of occluding shell segments 101 are addressed by the use of LED lights 104. The LED lights 104 provide additional illumination to mitigate the drop in luminosity of the vehicle's exterior lighting system.

In one embodiment, the LED lights 104 attached to the eyelids are capable of functioning as auxiliary lights and capable of working in conjunction with the vehicle's exterior lighting system. Electricity power and light signals are sent to the LED light strip 105 from the vehicle via a cable 108. The cable 108 connects to the vehicle's exterior lighting system and receives power via an adapter 109. The LED lights 104 light up in various configurations and patterns in accordance to the signals received from the vehicle's exterior lighting system. The various configurations and patterns include daytime running lights, turn signals, brake lights, and parking lights.

### DETAILED DESCRIPTION OF THE FIGURES

In FIG. 1, a drawing of a singular LED headlamp eyelid segment installed on the top of a vehicular headlamp from the front is disclosed. The LED headlamp eyelid is installed on the top of the exterior vehicular headlamp. The convex surface of the shell 101 is the front 102 of the LED headlamp eyelid. The exterior of the front 102 of the LED headlamp eyelid is made transparent to reveal the back 103. The back 103 consists of a concave surface suitable for attachment of LEDs or LED light strips. The LED headlamp eyelid occludes the headlight along the top edge of the headlamp.

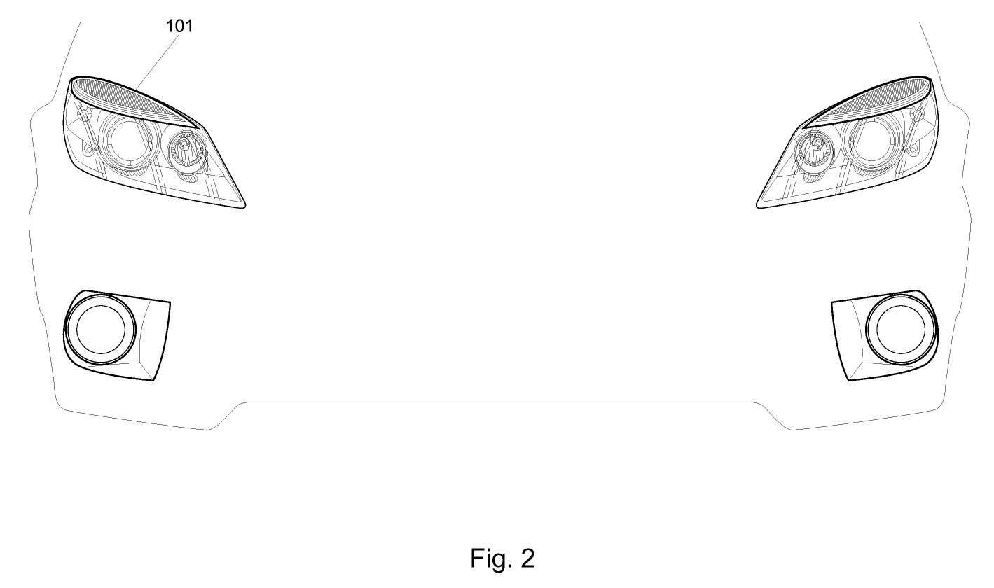

In FIG. 2, a drawing of a pair LED headlamp eyelids installed on a pair of vehicular headlamps from the front of a vehicle is disclosed. A singular segment 101 is installed on the top edge of the exterior of each vehicular headlamp. The LED headlamp eyelid occludes the headlight along the top edge of both the vehicle's headlamps.

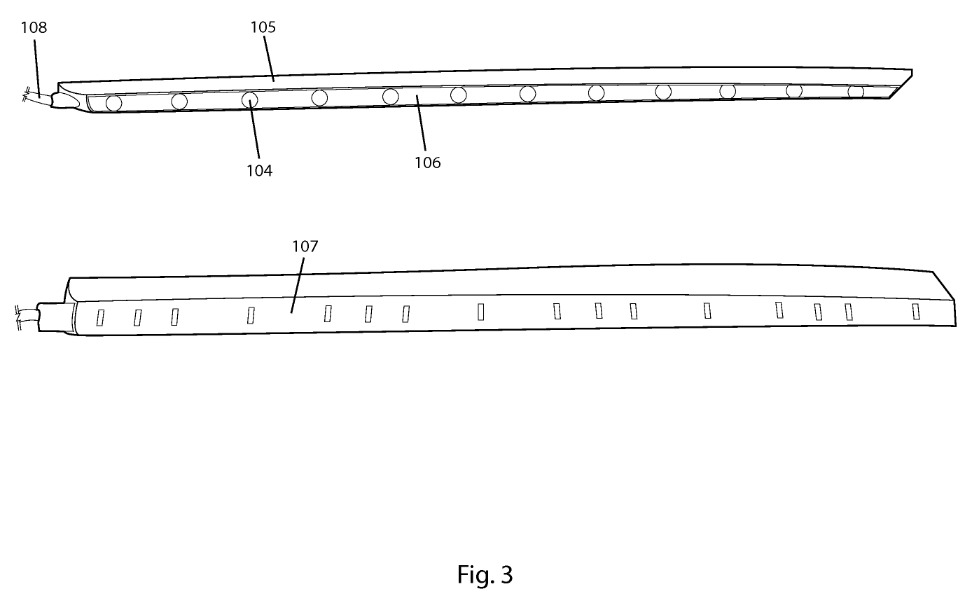

In FIG. 3, a drawing of an LED light strip from the front and from the back is disclosed. The LED light strip 105 contains one or more embedded LED lights 104 at intermittent intervals along the length of the front side 106 of the flexible housing. The back side 107 of the LED light strip 105 is attached to the back surface 103 of the LED headlamp eyelid shell 101. An electrical cable 108 carries electrical signals and electricity power from the vehicle to the LED light strip 105. These signals are converted into lighting instructions illuminating the designated LED lights 104 on the LED light strip 105.

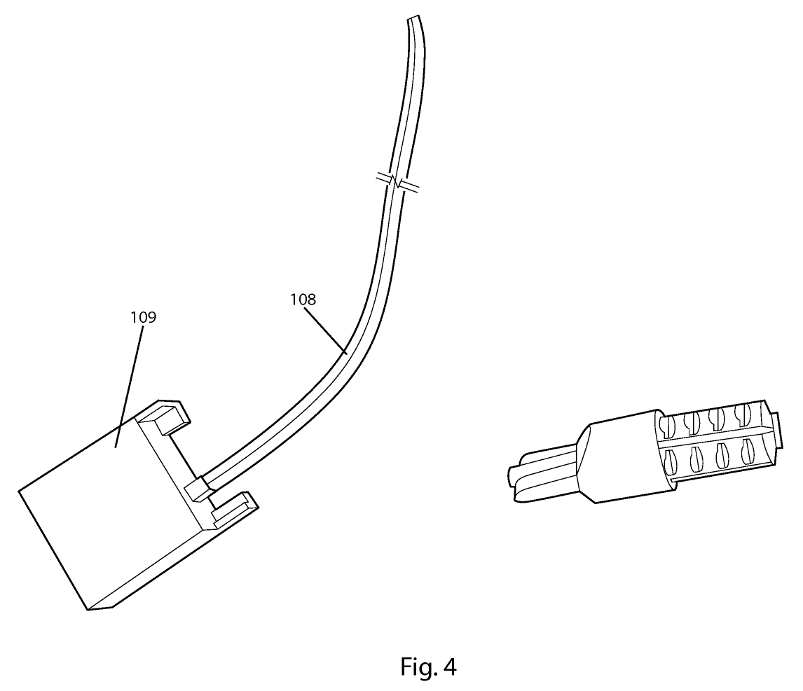

In FIG. 4, a drawing of the terminal end of the cable of the LED light strip is disclosed. A cable 108 transmits electrical signals and electricity power from the vehicle to the LED light strip 105. An adapter 109 connects the LED light strip 105 to the vehicle's plug. Power and signals from the vehicle's exterior lighting system are sent from the vehicle to LED light strip 105. The LED lights 104 on the LED light strip 105 are illuminated with respect to the signals received from the vehicle.

1. A vehicular lighting apparatus comprising:
a. a shell suitable for installation on the exterior of a headlamp of a vehicle; wherein said headlamp emits a projected light beam.
b. one or more LED lights attached to said shell.

2. The apparatus of claim 1 wherein said shell comprises of one or more segments.

3. The apparatus of claim 2 wherein occlusion of said headlamp by said segments modifies the overall shape of the projection of said projected light beam.

4. The apparatus of claim 1 wherein said shell is constructed at least in part of lightweight material.

5. The apparatus of claim 4 wherein said lightweight material is vinyl.

6. The apparatus of claim 4 wherein said lightweight material is polyurethane.

7. The apparatus of claim 4 wherein said lightweight material is carbon fiber.

8. The apparatus of claim 4 wherein said lightweight material is acrylic.

9. The apparatus of claim 1 wherein said apparatus is mounted onto said vehicle by means of adhesives.

10. The apparatus of claim 1 wherein said apparatus is mounted onto said vehicle by means of magnets.

11. The apparatus of claim 1 wherein said LED lights are interchangeable with colored LED lights.

12. The apparatus of claim 11 wherein said LED lights are capable of illuminating and functioning as turn signals.

13. The apparatus of claim 11 wherein said LED lights are capable of illuminating and functioning as daytime running lights.

14. The apparatus of claim 11 wherein said LED lights are capable of illuminating and functioning as parking lamps.

15. The apparatus of claim 11 wherein said LED lights are capable of illuminating and functioning as brake lamps.

16. An apparatus of claim 1 wherein said LED lights can be illuminated at variable intensity.

17. The apparatus of claim 1 wherein an adapter is to be connected to said vehicle wherein electricity power and signal input will be provided from said vehicle to said apparatus via an adapter.
